(19) United States
(12) Patent Application Publication
(10) Pub. No.: US 2006/0078188 A1
(43) Pub. Date: Apr. 13, 2006

(54) Method and its apparatus for classifying defects

(76) Inventors: Masaki Kurihara, Yokohama (JP); Hisae Shibuya, Chigasaki (JP); Toshifumi Honda, Yokohama (JP); Naoki Hosoya, Yokohama (JP); Atsushi Miyamoto, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/190,829

(22) Filed: Jul. 28, 2005

(30) Foreign Application Priority Data
Sep. 29, 2004 (JP) 2004-283013

(51) Int. Cl. G06K 9/00; G06K 9/62

(52) U.S. Cl. 382/149; 382/224

(57) ABSTRACT

In an automatic defect classifying method, defects not reviewed are assigned with defect classes having the same definitions as those of reviewed defects in order to effectively use information on defects not reviewed, the defects not reviewed occupying most of defects on a wafer. Defects not reviewed are assigned defect classes having the same definitions, by using defect data of defects detected with an inspection equipment and defect classes of already reviewed defects given by ADC of a review equipment. Since all defects are assigned the defect classes having the same definitions, more detailed analysis is possible in estimating the generation reasons of defects.

The present application claims priority from Japanese application JP2004-283013 filed on Sep. 29, 2004, the content of which is hereby incorporated by reference into this application.

### BACKGROUND OF THE INVENTION

The present invention relates to a method and apparatus for classifying defect types in accordance with defect data obtained by detecting foreign matters and defects formed on a semiconductor wafer specimen during semiconductor manufacture processes and detected with an inspection equipment.

During manufacturing a semiconductor wafer, the wafer processed by each manufacture process is inspected in order to detect defects formed on the wafer by an unsatisfactory manufacture process and adversely affecting a manufacture yield and to improve the yield. FIG. 4 illustrates inspection during conventional semiconductor manufacture processes.

For inspection, a combination of two inspection equipments is often used, one being suitable for detecting defects on a wafer 4201 at a preceding stage and the other having a high resolution capable of observing the details of defects at a succeeding stage although it is not suitable for detecting defects.

First, an inspection equipment 4202 detects defects on the wafer to obtain defect data 4203 of the detected defects including positions of the defects on the wafer, attribute amounts obtained by processes during the inspection. As the inspection equipment 4202, there are a foreign matter inspection equipment and a pattern inspection equipment of an optical type and a scanning electron microscope (SEM) type, and an inspection equipment having a function called automatic defect classification (ADC) which automatically classifies defect types (hereinafter called defect classes) on the basis of user definitions or equipment specific definitions. ADC of an inspection equipment provides a method described in JP-A-2002-256533.

Since the inspection equipment 4202 has as its object to detect defects on a wafer at high speed, it has a low resolution as compared to the sizes of defects existing on the wafer. Therefore, in order to acquire more detailed information, defects are observed in detail with an optical type or SEM type review equipment 4207 having a high resolution. In the following, observing defects with the review equipment is called “reviewing”. In accordance with defect information acquired through reviewing, defects are classified into detailed defect classes 4209 on the basis of definitions different from those of the inspection equipment 4202, by using the ADC function of the review equipment. Detailed information including the detailed defect classes 4209 acquired by the review equipment 4207 facilitates to estimate the reasons of forming the defects and allows to settle a means for improving a yield.

Acquiring detailed information on all defects on a wafer is ideal in order to completely grasp the formation states of defects on a whole wafer as many as possible and to perfectly deal with unsatisfactory manufacture processes as many as possible. However, it is practically impossible to review all defects from time restrictions, upon consideration of the number of wafers produced from time to time and the number of defects on the wafers. Therefore, only the defects sampled 4206 from detected defects on the basis of various criteria designated for sampling 4206 are reviewed, and in accordance with detailed information on the sampled defects, a means for improving a yield has been settled.

In order to improve this circumstance, a method of deciding defect classes of defects not reviewed is disclosed in US Patent Publication No. 6,408,219. This method re-classifies defect classes by collectively utilizing inspection information acquired by an optical type or SEM type inspection equipment and defect classes acquired by ADC of each inspection equipment.

JP-A-2004-47939 discloses a classifier designing method and a classifying method in a system configured by a plurality of defect inspection equipments, a classifier classifying defects into defect classes defined uniformly among the defect inspection equipments.

Defect classes classified through viewing become a sign of estimating the reasons of defect formation. Defect classes acquired by the inspection equipment are coarse classification such as distinguishment between scratches and foreign matters. Therefore, information on defects not reviewed are hardly used to estimate the reasons of defects.

According to conventional technologies, defects not reviewed are not assigned defect classes based on the same definitions as those for reviewed defects. Information on defects not reviewed cannot be used effectively.

Furthermore, it is not guaranteed that defects not reviewed are classified in detail to the same extent as that of defect classes on the basis of definitions used for classification by the review apparatus. It is possible to design a classifier for an inspection equipment capable of classifying by using the same definitions as those of the review equipment. However, the classifier is assumed to be used thereafter continuously so that there is a possibility of variation in classification criteria because of variation in inspection equipments and inspection objects day after day.

### SUMMARY OF THE INVENTION

The present invention provides an automatic defect classifying method of assigning defects not reviewed with defect classes having the same definitions as those of reviewed defects in order to effectively use information on defects not reviewed, the defects not reviewed occupying most of defects on a wafer.

Namely, according to the automatic defect classifying method of the present invention, in accordance with defect data obtained by an inspection equipment having a low resolution and defect classes classified by a review equipment having a high resolution, a classifier for classifying defects into the defect classes defined by the review equipment is designed, the defects not reviewed are assigned defect classes having the same definitions as those of the defect classes of defects reviewed, in accordance with defect data of defects not reviewed, obtained by the inspection equipment, and by using the designed classifier.

According to the present invention, all defects detected with the inspection equipment can be assigned defect classes defined by ADC of the review equipment. Information on the defects not reviewed can be effectively used. By adding SSA data and CAD data as an input, more detailed classification is possible and the generation reasons of defects can be estimated easily.

These and other objects, features and advantages of the invention will become apparent from the following more particular description of preferred embodiments of the invention, as illustrated in the accompanying drawings.

### BRIEF DESCRIPTION OF THE DRAWINGS

FIG. 1 is a flow chart illustrating an automatic defect classifying method according to a first embodiment of the present invention.

FIG. 2 is a flow chart illustrating an automatic defect classifying method according to another embodiment of the present invention.

FIG. 3 is a flow chart illustrating an automatic defect classifying method according to still another embodiment of the present invention.

FIG. 4 is a block diagram illustrating wafer inspection and a review system showing an example of a conventional automatic defect classifying method.

FIG. 5 is a block diagram illustrating wafer inspection and a review system according to an embodiment of the present invention.

FIG. 6 is a block diagram illustrating wafer inspection and a review system according to another embodiment of the present invention.

FIG. 7 is a block diagram illustrating wafer inspection and a review system according to still another embodiment of the present invention.

FIG. 8 is a flow chart illustrating a specific example of processes illustrated in the embodiment shown in FIG. 1.

FIG. 9A is a diagram explaining a case in which a distribution of defects represented by a two-dimensional attribute amount space is compressed to a linear attribute amount.

FIG. 9B is a diagram explaining a method of estimating the distribution of defects represented by the two-dimensional attribute amount space.

FIG. 10 is a flow chart illustrating another specific example of processes illustrated in the embodiment shown in FIG. 1.

FIG. 11A is a graph explaining a K-NM method as an example of a non-parametric learning classifier.

FIG. 11B is a graph explaining a threshold value process as an example of a rule base type classifier.

FIG. 12 is a diagram showing a typical user interface according to an embodiment of the present invention.

FIG. 13 is a diagram showing detailed examples of defect classes and defect data areas in the embodiment shown in FIG. 12.

FIG. 14 is a diagram showing a detailed example of a wafer map display area in the embodiment shown in FIG. 12.

FIG. 15A is a diagram showing a wafer map display area according to a second embodiment.

FIG. 15B is a diagram showing the details of defect classes and defect data areas.

FIG. 16 is a diagram showing the details of a wafer map display area of a user interface according to a third embodiment.

### DESCRIPTION OF THE EMBODIMENTS

Embodiments of the invention will be described with reference to the accompanying drawings.

### First Embodiment

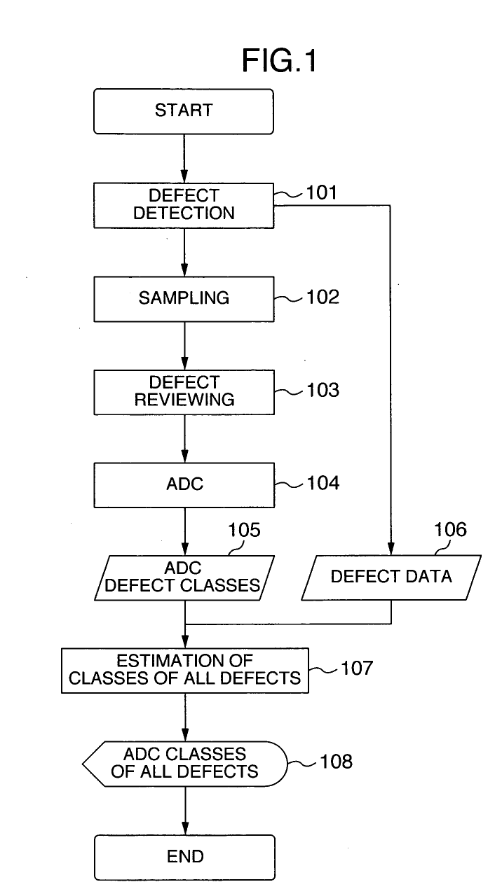

FIG. 1 is a flow chart illustrating processes of an automatic defect classifying method according to the first embodiment of the present invention. Defects on a wafer subjected to semiconductor manufacture processes and transported to an inspection process are detected with a conventionally well-known inspection equipment or the like (101). The inspection equipment calculates at least defect position coordinates and attribute amounts as information on defects (106). Defects to be reviewed are selected from the detected defects by conventionally well-known sampling (102).

Next, the selected defects are reviewed with a conventionally well-known SEM type review equipment or the like having a high resolution (103). Reviewed results are passed to a conventionally well-known ADC and classified into defect classes (104). In accordance with input defect classes 105 of ADC and defect data 106, defects not having defect classes of ADC are assigned the defect classes of ADC (107). All defects of the wafer are made to have correspondence with the defect classes of ADC (108).

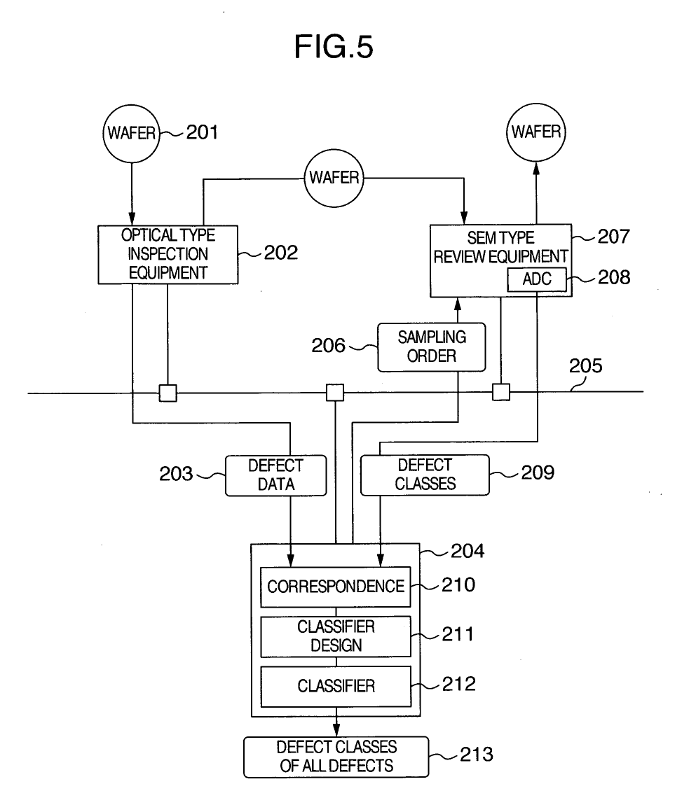

FIG. 5 is a diagram illustrating automatic defect classification in an inspection process for a semiconductor wafer adopting an automatic defect classifying method according to an embodiment of the present invention.

The structure of equipments to be used in the inspection process for semiconductor wafers is constituted of a combination of an optical type inspection equipment 202 and a SEM type review equipment 207 having a higher resolution than that of the optical type inspection equipment 202 and being capable of photographing an image of a semiconductor wafer 201. These equipment is connected to a server 204 via a LAN 205.

The optical type inspection equipment 202 calculates at least defect position coordinates on a wafer 201 and attribute amounts and sends defect data 203 including these information to the server 204.

The server 204 samples defects to be reviewed with the SEM type review equipment 207 from all defects in the input defect data 203 by using a conventionally well-known method, and sends a sampling order 206 to the SEM type review equipment 207.

In accordance with the received sampling order 206, the SEM type review equipment 207 reviews the corresponding defects. The SEM type review equipment 207 sends review data to an ADV 208 which is a conventionally well-known defect classifying method.

In accordance with the review data, ADC 208 decides defect classes 209 of the reviewed defects. The decided defect classes 209 are sent to the server 204 and made to have correspondence 210 with the defect data 203.

The defect data 203 having the correspondence 210 with the defect classes 209 is input to classifier design 211 in the server 204 to thereby divide the defect data into defect data having the defect class 209 and defect data not having the defect class 209. If an ADC (not shown) as a classifier for the defect data 203 is mounted on the optical type inspection equipment 202, this ADC may be redesigned. However, if ADC mounted on the optical type inspection equipment 202 is redesigned for some wafers, a correct classification answer factor of defect classes may possibly be lowered for other wafers. In this embodiment, therefore, the classifier is designed for each of all wafers to be reviewed, separately from ADC mounted on the optical type inspection equipment 202.

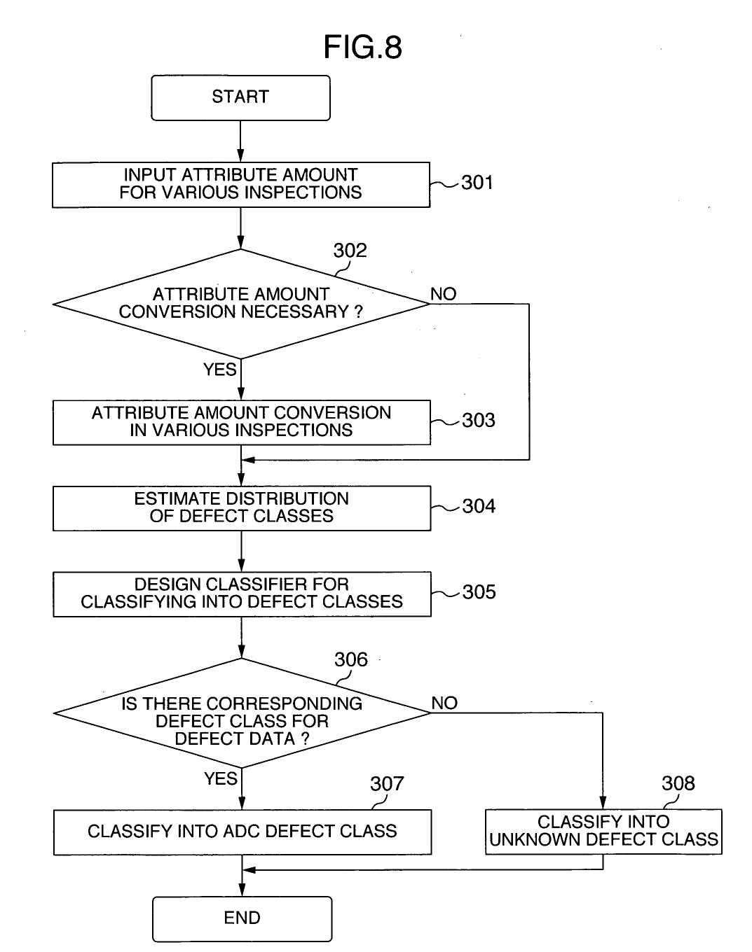

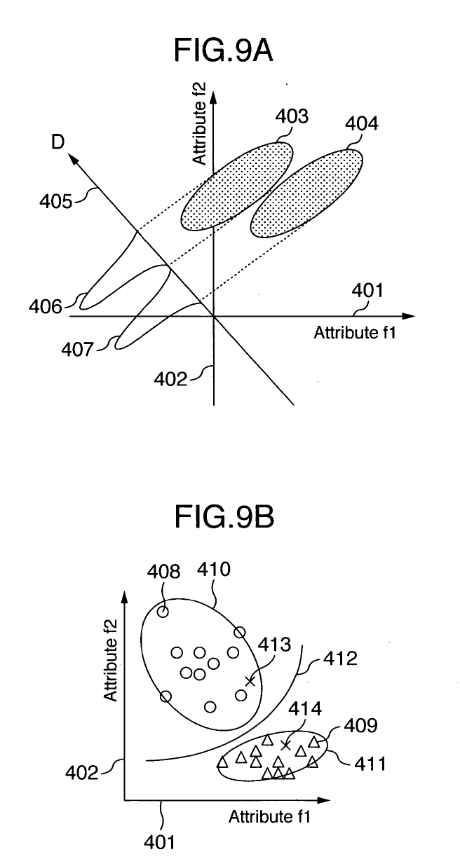

In designing a classifier for classifying defects not reviewed into defect classes, various well-known technologies can be utilized. Description will be made on embodiments of classifier design with reference to FIG. 8, FIGS. 9A and 9B, FIG. 10 and FIGS. 11A and 11B. FIG. 8 and FIGS. 9A and 9B illustrate an example of a design method for a parametric learning type classifier of pattern recognition. As illustrated in the flow chart of FIG. 8, first, the server 204 receives the defect data 203 output from the optical type inspection equipment 202 and the defect class information 209 output from ADC 208 of the review equipment 207 (301). Defect data is multi-dimensional attribute amounts and has redundant information in some cases. It is therefore checked whether it is necessary to convert the attribute amounts (302), and if necessary, dimension conversion is executed to delete redundant information to convert the defect data (303).

Next, an arithmetic model is estimated for the distribution of defects in the attribute amounts of the defect data, and parameters of the model are estimated to estimate the defect distribution (304). The classifier for judging defect classes is designed in accordance with the degree of model adaptability to defect data of defects to be classified (305). Judgement is made by using the designed classifier (306), and if there is a corresponding defect class, this class is assigned to the defect data (307), whereas if not, the defect data is classified to an unknown defect (308).

FIG. 9A is a diagram detailing dimension compression. The dimension compression will be described by taking as an example, compression of two-dimensional attribute amounts into one-dimension. Consider now the classification of two defect class distributions 403 and 404 on a plane of two dimensions 401 and 402. Projection of the two defect class distributions upon one-dimensional straight line D 405 provides the best separation of defect class distributions 406 and 407 after projection. The distribution can be expressed on the one-dimensional straight line D 405 after the dimension compression.

FIG. 9B is a diagram illustrating the details of estimation of defect distributions. As an example, defects are assumed to have a distribution of two dimensions 401 and 402. There are learning samples of two classes 408 and 409 on the plane of two dimensions 401 and 402. The arithmetic model of distributions is assumed to be p(f₁, f₂|ωᵢ)=gᵢ(f₁, f₂, θ) (i=1, 2) where f₁ and f₂ represent an attribute amount, ωᵢ represents a class, and p(x|ωᵢ) represents a distribution density function of attribute amounts. If the parameter θ is estimated, for example, by the maximum likelihood method, the defect distribution of the class ωᵢ can be estimated. Estimated distributions on the original two-dimensional plane are represented by 410 and 411.

Next, description will be made on the classification using the classifier design 211 and designed classifier 212. The classifier design is to decide a border line 412 for classifying the two defect class distributions 410 and 411 on the plane of the two dimensions 401 and 402. In this case, the border line 412 is a curve satisfying g₁(f₁, f₂)=g₂(f₁, f₂). A defect 413 satisfying g₁(f₁, f₂)>g₂(f₁, f₂) relative to the curved border line is assigned the defect class 408, whereas a defect 414 satisfying g₁(f₁, f₂)<g₂(f₁, f₂) is assigned the defect class 409.

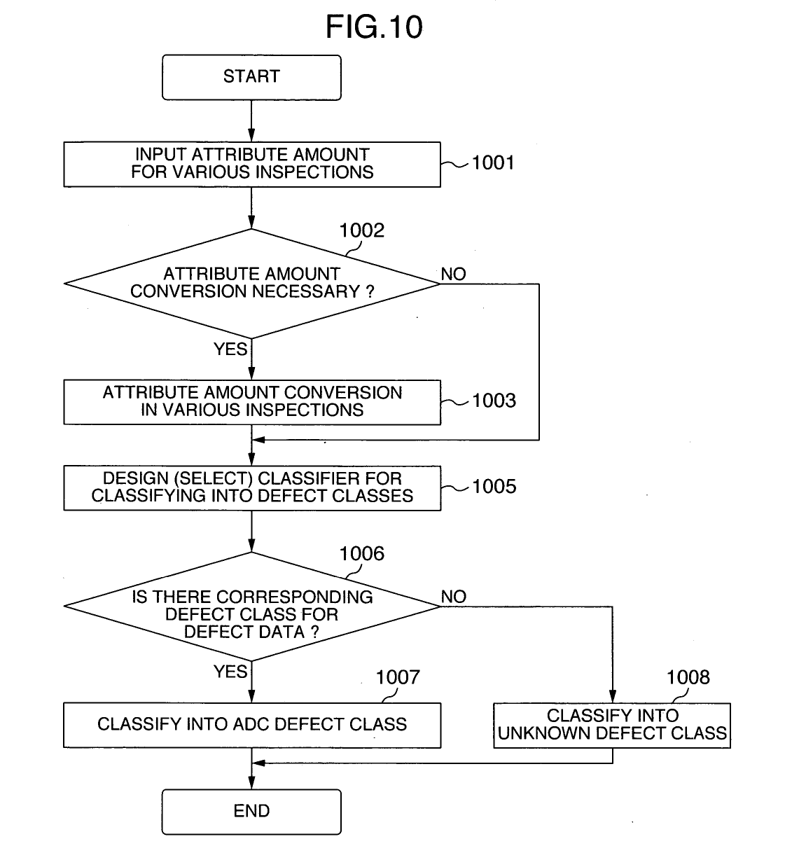

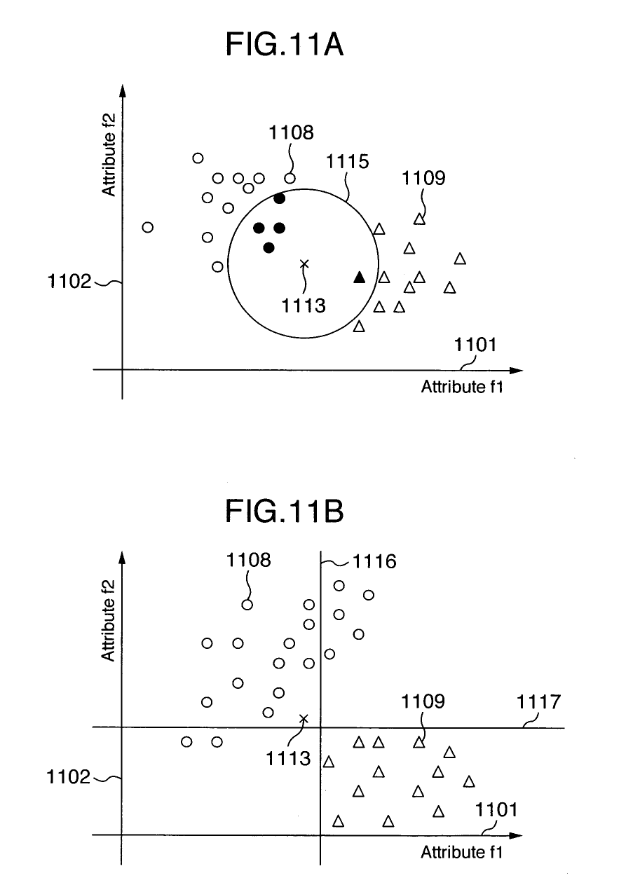

With reference to FIG. 10 and FIGS. 11A and 11B, description will be made on a design method for a non-parametric learning type classifier of pattern recognition and a rule base type classifier as the classifier 212 by the classifier design 211. Similar to the design method for the parametric learning type classifier described with reference to FIG. 8 and FIGS. 9A and 9B, the server 204 receives the defect data 203 output from the optical type inspection equipment 202 and the defect class information 209 output from ADC 208 of the review equipment 207 (1001). It is checked whether it is necessary to convert the attribute amounts (1002), and if necessary, dimension conversion is executed to delete redundant information to convert the defect data (1003).

Next, not classifier design but selection is performed if the non-parametric learning type classifier is used, whereas design for a classification conditional equation is made if the rule base type classifier is to be used (1005). The processes 1006, 1007 and 1008 to follow are similar to those for the parametric learning type classifier described with reference to FIG. 8 and FIGS. 9A and 9B.

With reference to FIGS. 11A and 11B, description will be made on a k-NN method as an example for the non-parametric learning type classifier and a threshold value process as an example of the rule base type classifier. FIG. 11A is a diagram illustrating the k-NN method as an example for the non-parametric learning type classifier. Description will be made on classifying a sample 1113 when there are learning samples of two defect classes 1108 and 1109 on the plane represented by attribute amounts of two dimensions 1101 and 1102.

According to the k-NN method, k learning samples are extracted having a shorter distance to the center of the object defect sample 1113. The defect sample is classified into the defect class to which the maximum number of defect samples among the k samples belongs. In the example of FIG. 11A, k is set to 5. The extraction range is inside a circle 1115. It is decided from the learning samples (indicated by • and ▴ in FIG. 11A) that the sample 1113 belongs to the defect class 1108.

FIG. 11B is a diagram illustrating the threshold value process as an example for the rule base type classifier. According to the threshold value process, threshold values 1116 and 1117 are decided which divide the learning samples into two defect classes 1108 and 1109. Although these threshold values 1116 and 1117 can be automatically decided, they are generally decided manually by a user. The object sample 1113 is classified into the defect class 1108.

The attribute amounts of the defect data of defects not reviewed are input to the classifier 212 designed by the classifier design 211, and the server 204 performs the defect classification in accordance with the above-described criterion and outputs the classified defect classes 213 of all defects.

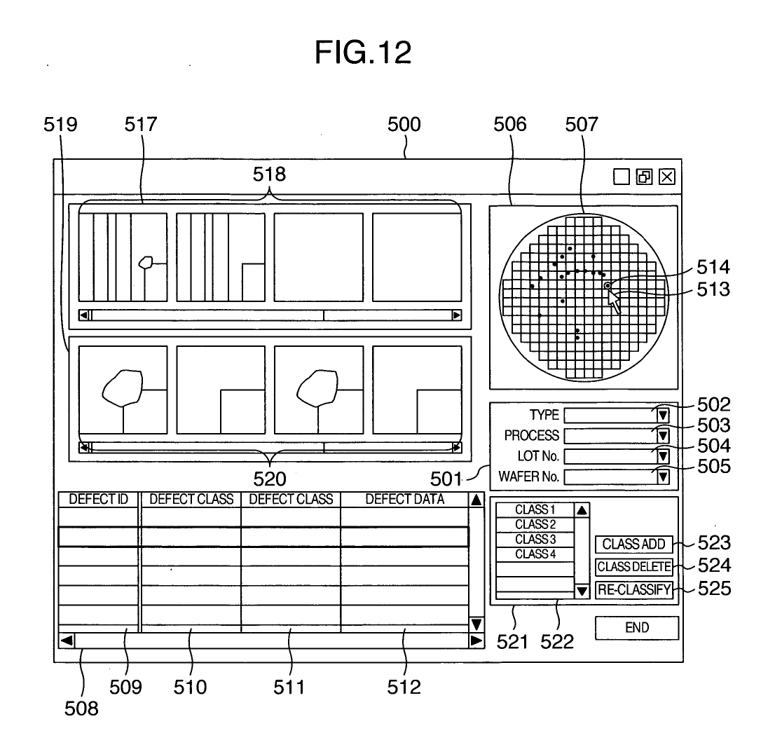

The assigned defect classes are displayed in correspondence with the defect data. FIG. 12 shows an example of a display screen. The display screen is constituted of a wafer information area 501, a wafer map area 506, a defect class and defect data area 508, a view area 517, a detailed view area 519 and a defect class area 521.

The wafer information area 501 receives information on an object wafer supplied from a user. Typical information used for identifying a wafer includes a wafer type 502, a process type 503, a lot number 504, a wafer number 505 and the like. These information is used for identifying a particular wafer among a number of wafers processed and analyzed in a manner described in the embodiments of the invention and thereafter preserved.

The wafer map area 506 displays the information on the wafer identified in the wafer information area. The wafer map area 506 has a display area (hereinafter a wafer map display area indicates the display area 507) 507 for displaying an image representative of the selected wafer or other suitable information. The displayed image or other information is called a wafer map, and similar to a conventional example, the wafer map shows the distribution state of detected defects on a wafer. The wafer map formed from the defect data indicates the coordinate positions of each defect on the wafer. Defects displayed on the wafer map are displayed in different colors between the defects already reviewed with the review equipment and the defects not reviewed.

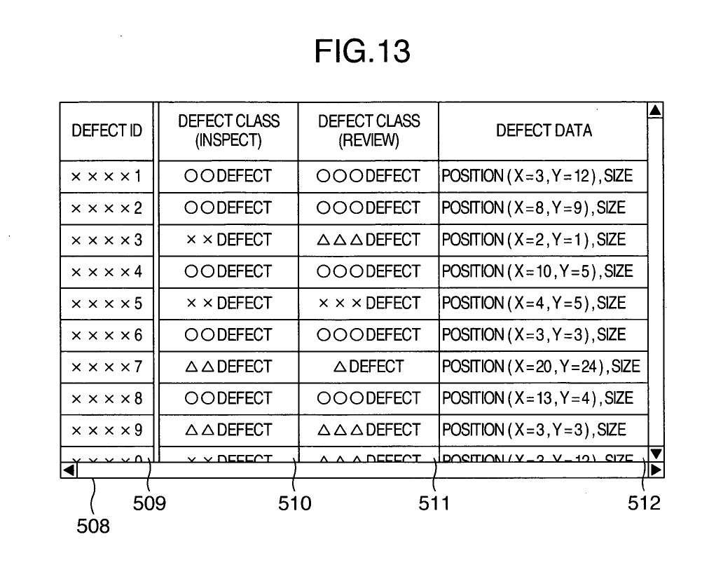

FIG. 13 shows the details of the defect class and defect data area 508. The defect class and defect data area 508 displays a defect ID 509, a defect class 510 given by the inspection equipment, a defect class 511 assigned by the review equipment and the automatic defect classifying method of the invention, defect data 512 and the like. The defect data 512 displays, in a row, position coordinates of a defect on a wafer and an attribute amount of the defect detected with the inspection equipment. Each defect in the defect class and defect data area 508 cooperates with each defect displayed in the wafer map display area 507. A data field 516, corresponding to a defect 514 (defect indicated by a pointer 513 in the screen) selected in the wafer map display area 507, is displayed emphatically in the defect class and defect data area 508. Conversely, as the data field 516 in the defect class and defect data area 508 is pointed out with a pointer 515, a position 514 on the wafer map display area 507 of a defect corresponding to the data field is displayed emphatically.

The view area 517 displays an image of a defect selected by the pointer 513 or 515 in the wafer map display area 507 or defect class and defect data area 508 and photographed with the optical type inspection equipment 202, and other images. The view area 517 has display areas 518 for displaying an image of a defect, a reference image showing the same area of the wafer without a defect, and other images.

The detailed view area 519 displays an image of a defect selected by the pointer 513 or 515 in the wafer map display area 507 or defect class and defect data area 508 and photographed with the review equipment 207. The detailed view area 519 has display areas 520 similar to those of the view area 517.

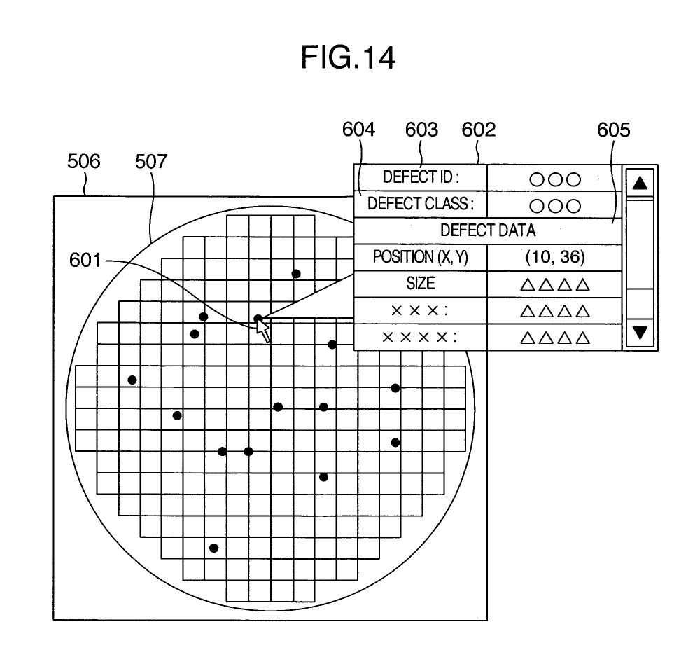

The defect class area 521 is constituted of a class display area 522 for defects, a class add button 523 and a class delete button 524. By referring to images and defect data displayed in the view area 517 and detailed view area 519, a user can judge to add or delete any defect class. Some or all defects can be moved by dragging and dropping fields of the defect class and defect data display area to the corresponding classes in the defect class display area 522. As a re-classification button 525 is depressed after defect classes are added or deleted, the classifier is re-designed and re-classified only when a reviewed defect of learning data is moved to a new defect class. If a defect not reviewed is moved to a new defect class, the moved defect is retained even if the re-classification button 525 is depressed. After the re-classification, the defect class display area 522 for defects is updated and displayed. The defect class and defect data display area may be an alternative area such as shown in FIG. 14. As a defect 601 displayed in the wafer map display area 507 is selected, the defect class and defect data area is displayed in another area 602 in which a defect ID 603, a defect class 604, defect data 605 and the like are displayed.

### Second Embodiment

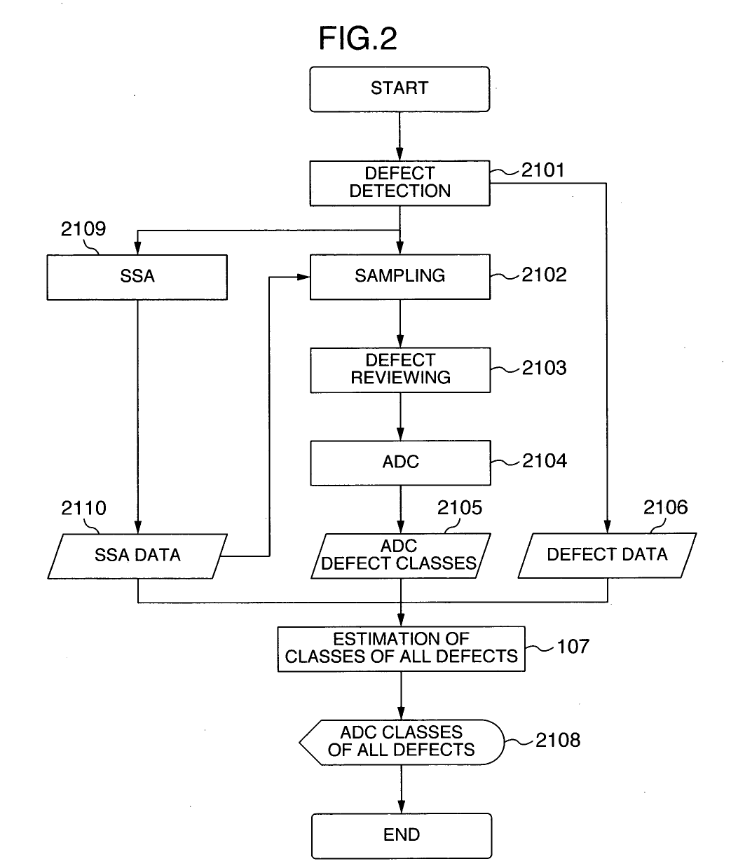

FIG. 2 shows the second embodiment of the invention.

In the second embodiment, steps from a defect detection 2101 to ADC defect classes 2105 are the same as the defect detection 101 to the ADC defect classes 105 shown in FIG. 1. A different point from the first embodiment resides in that after the defect detection 2101, a spatial signature analysis (SSA) 2109 is executed which analyzes the defect distribution state and SSA data 2110 of the analysis result is input to a sampling 2102 and a class estimation 2107 for all defects.

A defect distribution of a wafer is generally shifted because of performances specific to equipments and processes. SSA 2109 has been proposed to analyze the defect distribution state from defect position information on a wafer. For example, a method disclosed in JP-A-2003-059984 is used for SSA. According to this method, defects are classified into defects having an area of a defect distribution attribute class and random defects, depending upon the distribution state. The defects having the area include repetitive defects existing at generally same positions of a plurality of chips, dense defects having very short distances to nearby defects in a wafer map, and other defects. The random defects have a defect distribution different from that of the defects having the area. The SSA data 2110 output from SSA 2109 includes at least the defect distribution attribute class.

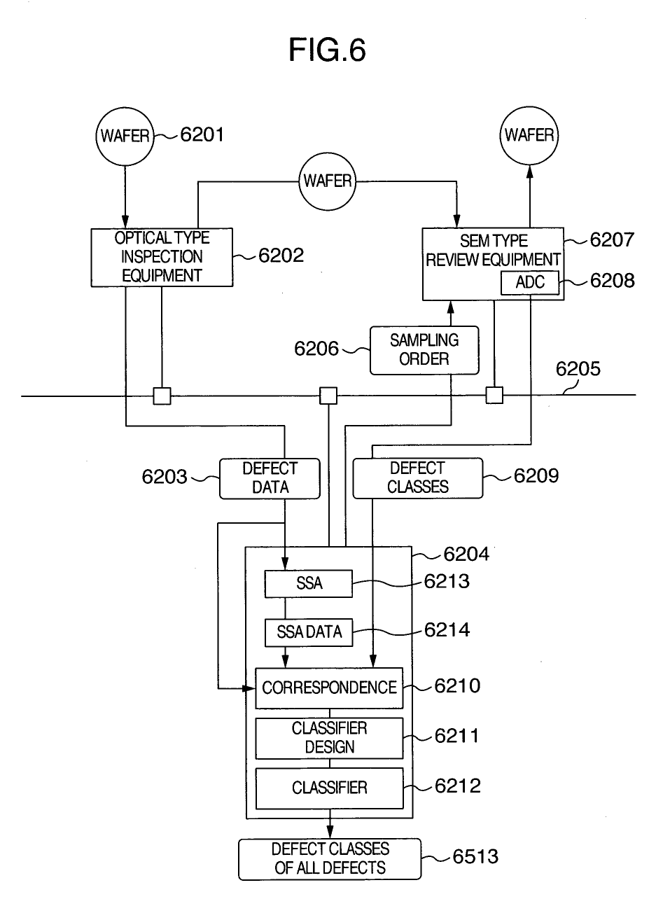

FIG. 6 is a diagram illustrating the second embodiment of the invention applied to an inspection process for semiconductor wafers.

Similar to the first embodiment described with reference to FIG. 5, the structure of equipments to be used in the inspection process for semiconductor wafers is constituted of a combination of an optical type inspection equipment 6202 and a SEM type review equipment 6207 having a higher resolution than that of the optical type inspection equipment 202. These equipments are connected to a server 6204 via a LAN 6205.

Similar to the first embodiment described with reference to FIG. 5, the optical type inspection equipment 6202 calculates at least defect position coordinates on a wafer 6201 and attribute amounts and sends defect data 6203 including these information to the server 6204.

The server 6204 samples defects to be reviewed with the SEM type review equipment 6207 from all defects in the input defect data 6203 by using a conventionally well-known method, and sends a sampling order 6206 to the SEM type review equipment 6207.

In accordance with the received data, the SEM type review equipment 6207 reviews the corresponding defects. The SEM type review equipment 6207 sends review data to an ADC 6208 which is a conventionally well-known defect classifying method.

In accordance with the review data, ADC 6208 decides defect classes 6209 of the reviewed defects. The decided defect classes 6209 are sent to the server 6204 and made to have correspondence 6210 with the defect data 6203.

The defect data 6203 having the correspondence 6210 with the defect classes 6209 is input to a classifier design 6211 in the server 6204 to thereby divide the defect data into defect data having the defect class and defect data not having the defect class. If an ADC (not shown) as a classifier for the defect data 6203 is mounted on the optical type inspection equipment 6202, this ADC may be redesigned. However, if ADC mounted on the optical type inspection equipment 6202 is redesigned for some wafers, a correct classification answer factor of defect classes may possibly be lowered for other wafers. In this embodiment, therefore, the classifier is designed for each of all wafers to be reviewed, separately from ADC mounted on the optical type inspection equipment 6202.

In the second embodiment, as described above, the defect data 6203 is input from the optical type inspection equipment 6202 to SSA 6213 in the server 6204, and the SSA data 6214 output from SSA is input to a classifier design 6211 via the defect classes 6209 and correspondence 6210.

Not only SSA 6213 is used for the classifier design 6211, but also effective sampling is possible by using the SSA data 6214. For example, there is a sampling method proposed in “Outer Appearance Inspection Method Using Defect Point Sampling Technique”, the 13-th Work Shop of Automation of Outer Appearance Inspection, pp. 99-104 (December 2001).

The SSA data 6214 is different from the defect data 6203 obtained from images taken with the optical type inspection apparatus 6202, and depends on the defect distribution on the wafer 6201. It is therefore considered that the SSA data has a low correlation with the defect data 6203. The defect distribution attribute class contained in the SSA data 6214 is assigned to all defects, as different from the defect classes 6209 assigned by the review equipment 6207. Therefore, a classifying method may be considered by which before the defects not reviewed are supplied to the classifier 6212, a main mode in which defects exist being locally shifted on a semiconductor wafer and another mode are used for each defect distribution attribute class, and defects not reviewed and having the mode other than the main mode are classified. This method depends on the knowledge that the generation reasons of locally shifted defects on a semiconductor wafer are the same and the defects can be classified into defect classes.

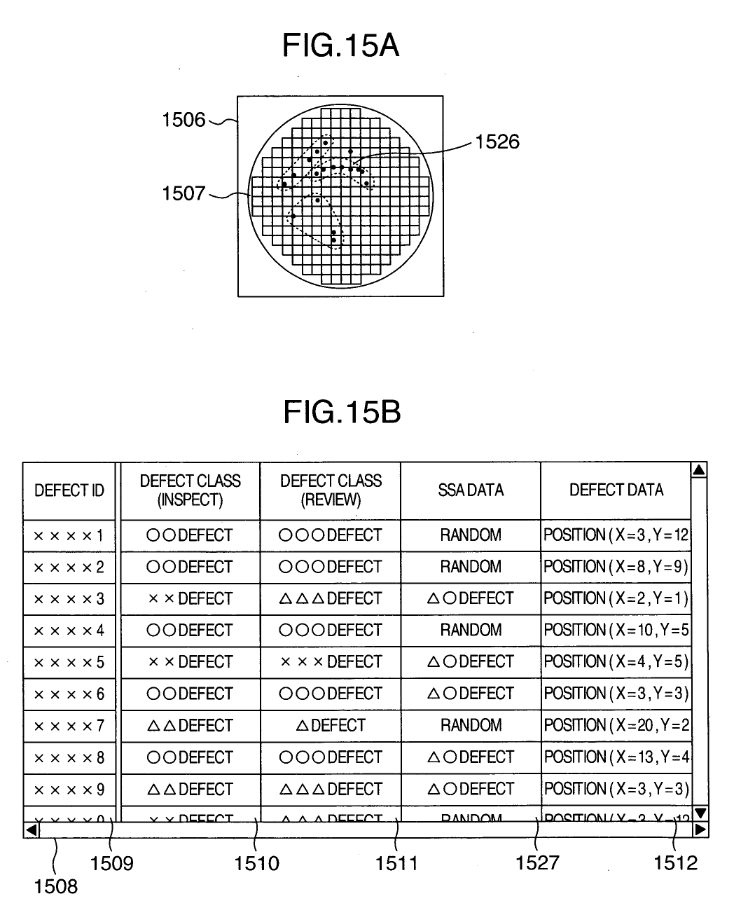

FIGS. 15A and 15B show a display area 1506 and a defect class and defect data area 1508. The display area 1506 corresponds to the wafer map area 506 of the first embodiment shown in FIG. 12. A spatial distribution of defects is displayed by closed curves 1526 in a wafer map display area 1507. Defects in an area surrounded by the closed curve 1526 in the wafer are classified into the same defect distribution attribute class of SSA. The structure of the defect class and defect data area 1508 shown in FIG. 15B has almost the same structure as that shown in FIG. 13. An SSA data display area 1527 is newly added for displaying the defect distribution attribute class of SSA.

### Third Embodiment

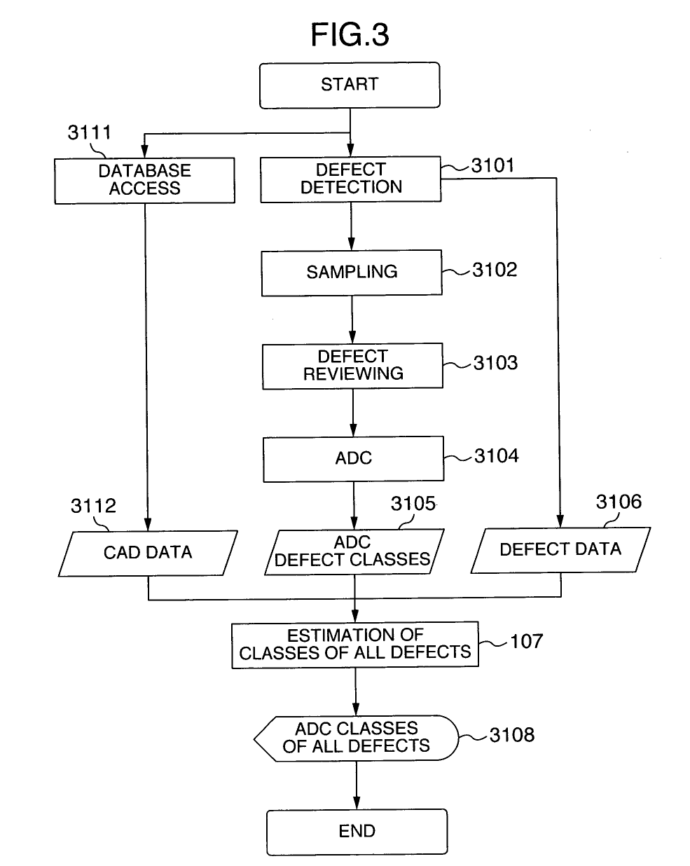

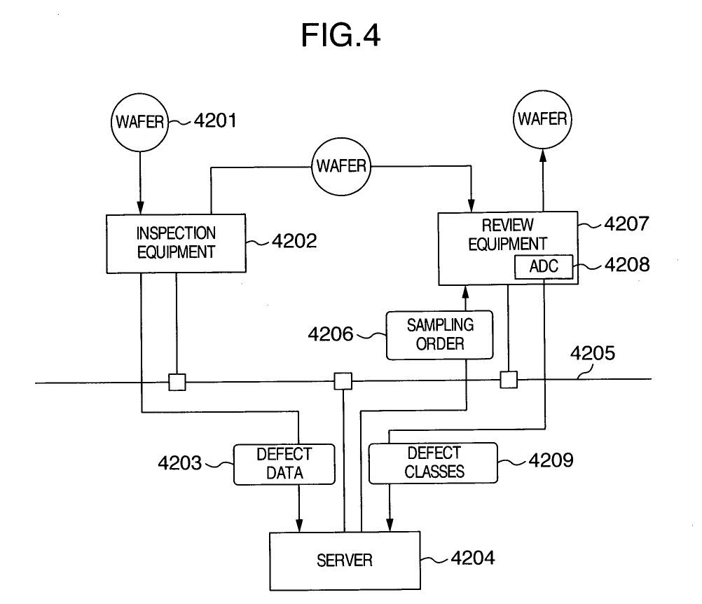

FIG. 3 illustrates the third embodiment.

In the third embodiment, steps from a defect detection 3101 to ADC defect classes 3105 are the same as the defect detection 101 to the ADC defect classes 105 shown in FIG. 1. A different point from the first embodiment resides in that before the defect detection 3101, a database is accessed 3111 to search computer aided design (CAD) data 3112 which is formed when chips in a semiconductor wafer are designed and describes the chip layout of two dimensions and a plurality of layers, and the searched data is input to a class estimation 3107 for all defects.

Defect data 3106 obtained by the defect detection 3101 has a smaller amount of information for classification than the information obtained by a defect review 3103, because a resolution of the inspection equipment is low. By using the CAD data 3112 of a wafer with defects, it becomes possible to obtain information on a pattern density, a pattern edge density and the like of the wafer with defects.

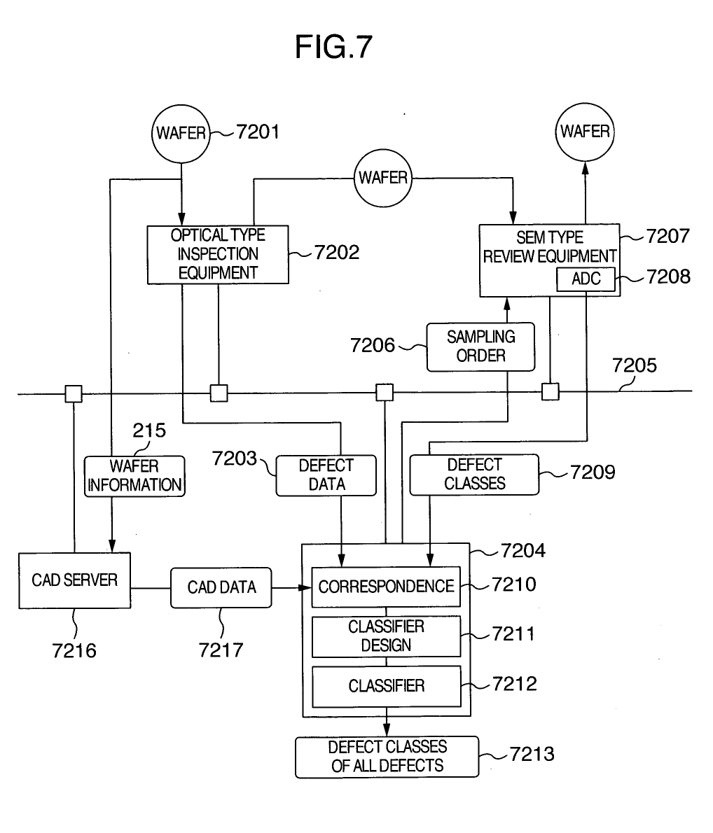

FIG. 7 is a diagram illustrating the third embodiment of the invention applied to an inspection process for semiconductor wafers. A different point of the third embodiment from the first embodiment resides in that wafer information 7215 is input to a CAD server 7216 and CAD data 7217 from the CAD server 7216 is input to a classifier design 7211.

Since the CAD data 7217 does not have information directly related to defects, the CAD data is matched with defect data 7203 when it is input to a classifier design 7211, to thereby convert into a numerical value representative of the relation between defects and areas in which the defects exist. For example, obtained is a numerical value representative of a ratio of an area of patterns in the area other than defects in an image, to the total area.

This numerical value together with the attribute amounts of the defect data 7203 is used as the attribute amounts of defects to make the classifier design 7201 design a classifier 7212.

The attribute amounts of defects become different depending upon how the areas in which defects exist are viewed in an image photographed with an optical type inspection equipment 7202. There is a possibility that even those defects having the same defect class are classified into different defect classes, if classification is performed in accordance with the defect data 7203 of the optical type inspection equipment 7202. Therefore, areas in which defects exist are classified by using the CAD data in accordance with a user defined criterion or an optionally defined criterion, and the classifier 7212 is designed by the classifier design 7211 to thereby classify defects into the same defect classes as those of the reviewed defects in each classified area.

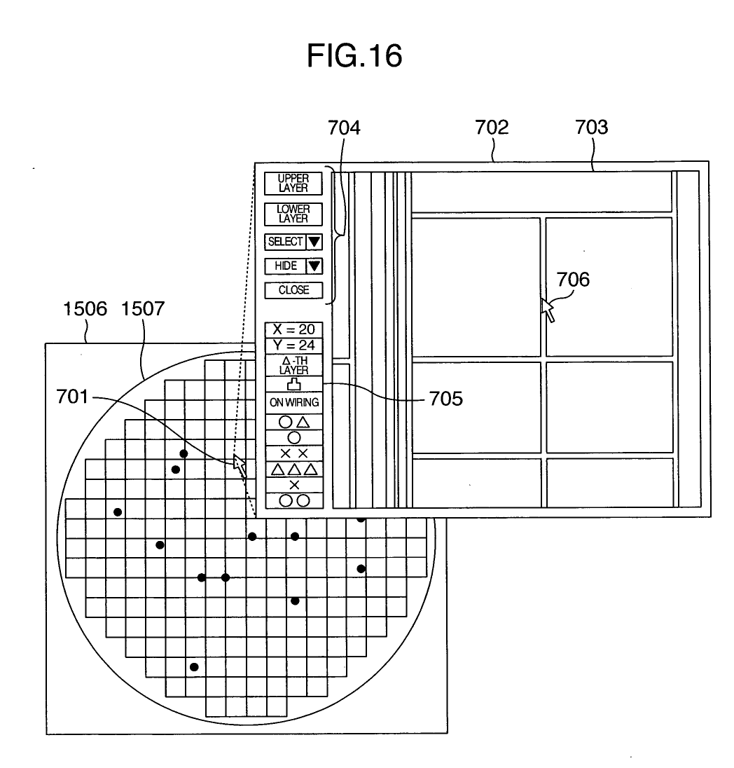

FIG. 16 shows a CAD data display area. As an optional point 701 in a wafer map display area 6507 (same as the wafer map display area 507 shown in FIG. 12) is selected, a CAD data display area 702 is displayed as another display area. The CAD data display area 702 is constituted of a CAD data image display area 703, buttons 704 for layer change, pattern display switching and the like, and a CAD data numerical value display area 705.

An image of the CAD data 7217 is displayed in the CAD data image display area 703. By depressing the buttons 704 for layer change, pattern display switching and the like, corresponding images are displayed. Each layer is displayed in different color and in a superposed manner.

As a desired point 706 in the CAD data image display area 703 is selected, the coordinates, the number of layers, CAD attribute amounts and the like of the selected point are displayed in the CAD data numerical value display area 705.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A defect classifying method comprising steps of:
inputting information on defects on a specimen detected with an inspection equipment;
notifying a detail observing equipment of information on defects to be observed in detail among said input information of the defects;
inputting classification information of said defects to be observed in detail, said defects to be observed in detail being classified through observation of said detail observing equipment on the basis of said notification;
designing a classifier for classifying said input information of defects, in accordance with a relation between said input classification information of said defects to be observed in detail and said input information of defects corresponding to said defects to be observed in detail; and
classifying said input information of defects by using said designed classifier.

2. The defect classifying method according to claim 1, wherein:
in said step of designing said classifier, said detected defects are classified into defects shifted on said specimen and defects not shifted, in accordance with said information of defects input from said inspection equipment, and said classifier for said defects not shifted is designed in accordance with said classification information obtained through observation of said detail observing equipment; and
in said classifying step, said defects not shifted are classified by said designed classifier.

3. The defect classifying method according to claim 1, wherein in said step of designing said classifier, CAD information is further used which was generated when said specimen was designed.

4. The defect classifying method according to claim 1, wherein in said classifying step, all defects input from said inspection equipment are classified by using said designed classifier.

5. The defect classifying method according to claim 1, wherein in said classifying step, said defects detected with said inspection equipment are displayed on a map of a screen and all defects displayed on said map are classified by using said classifier.

6. A defect classifying method comprising steps of:
designing a classifier for classifying defects detected with an inspection equipment into defect classes defined by a review equipment, in accordance with information on the defects obtained by inspecting a specimen with said inspection equipment having a low resolution and defect classification information classified by observing defects sampled from said defects detected with said inspection equipment with said review equipment having a high resolution; and
assigning defects not observed with said review equipment among said defects detected with said inspection equipment, with same defect classes as defect classes of said observed defects, in accordance with said information of defects obtained by said inspection equipment, and by using said designed classifier.

7. The defect classifying method according to claim 6, wherein:
in said step of designing said classifier, said detected defects are classified into defects shifted on said specimen and defects not shifted, in accordance with said information of defects input from said inspection equipment, and said classifier for said defects not shifted is designed in accordance with said classification information obtained through observation of said detail observing equipment; and
in said defect class assigning step, said defects not shifted are classified by said designed classifier.

8. The defect classifying method according to claim 6, wherein in said defect class assigning step, all defects input from said inspection equipment are classified by using said designed classifier and assigned said defect classes.

9. The defect classifying method according to claim 6, wherein in said defect class assigning step, said defects detected with said inspection equipment are displayed on a map of a screen and all defects displayed on said map are classified by using said classifier.

10. The defect classifying method according to claim 6, wherein in said step of designing said classifier, CAD information is further used which was formed when said specimen was designed.

11. A defect classifying equipment comprising:
first input means for inputting information on defects on a specimen detected with an inspection equipment;
notifying means for notifying a detail observing equipment of information on defects to be observed in detail among said information of the defects input from said first input means;
second input means for inputting classification information of said defects to be observed in detail, said defects to be observed in detail being classified through observation of said detail observing equipment on the basis of notification of said notifying means;
classifier designing means for designing a classifier for classifying data of defects input from said first input means, in accordance with a relation between said classification information of said defects to be observed in detail, input form said second input means and said input data of defects corresponding to said defects to be observed in detail; and
defect classifying means for classifying said input data of defects by using said classifier designed by said classifier designing means.

12. The defect classifying equipment according to claim 11, wherein:
said classifier designing means includes a defect distribution calculation unit for classifying said detected defects into defects shifted on said specimen and defects not shifted, in accordance with said information of defects input from said inspection equipment, and a classifier designing unit for designing a classifier for said defects not shifted, classified by said defect distribution calculation unit, in accordance with said classification information obtained through observation of said detail observing equipment; and
said defect classifying means classifies said defects not shifted, by using said classifier designed by said classifier designing means.

13. The defect classifying equipment according to claim 11, wherein said defect classifying means classified all defects input from said inspection equipment.

14. The defect classifying equipment according to claim 11, further comprising display means having a display screen, wherein said defects detected with said inspection equipment are displayed on said display screen of said display means in a map shape and all defects displayed in the map shape are classified by said defect classifying means by using said classifier.

15. The defect classifying equipment according to claim 11, wherein classifier designing means designs said classifier by further using CAD information which was generated when said specimen was designed.

16. A defect classifying equipment comprising:
classifier designing means for designing a classifier for classifying defects detected with an inspection equipment into defect classes defined by a review equipment, in accordance with information on the defects obtained by inspecting a specimen with said inspection equipment having a low resolution and defect classification information classified by observing defects sampled from said defects detected with said inspection equipment with said review equipment having a high resolution; and
defect classifying means for assigning defects not observed with said review equipment among said defects detected with said inspection equipment, with same defect classes as defect classes of said observed defects, in accordance with said information of defects obtained by said inspection equipment, and by using said designed classifier.

17. The defect classifying equipment according to claim 16, wherein:
said classifier designing means includes a shifted defect extracting unit for classifying said detected defects into defects shifted on said specimen and defects not shifted, in accordance with said information of defects input from said inspection equipment, and a classifier designing unit for designing a classifier in accordance with said classification information obtained through observation of said detail observing equipment.

18. The defect classifying equipment according to claim 16, wherein said defect classifying means classified all defects input from said inspection equipment.

19. The defect classifying equipment according to claim 16, further comprising display means having a display screen, wherein said defects detected with said inspection equipment are displayed on said display screen of said display means in a map shape and all defects displayed in the map shape are classified by said defect classifying means by using said classifier.

20. The defect classifying equipment according to claim 16, wherein classifier designing means designs said classifier by further using CAD information which was generated when said specimen was designed.
